(19) United States
(12) Patent Application Publication
(10) Pub. No.: US 2010/0296181 A1
(43) Pub. Date: Nov. 25, 2010

(54) PLASTIC LENS

(76) Inventors: Yoshimitsu Nomura, Saitama-shi (JP); Tatsuhiko Obayashi, Minami-ashigara-shi (JP); Seiichi Watanabe, Odawara-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 12/863,695

(22) PCT Filed: Jan. 21, 2009
(86) PCT No.: PCT/JP2009/051286

§ 371 Date: Jul. 20, 2010

(30) Foreign Application Priority Data
Jan. 23, 2008 (JP) 2008-012645

(51) Int. Cl. G02B 7/02

(52) U.S. Cl. 359/811

(57) ABSTRACT

A second lens (15) of a concave meniscus type is formed from a plastic nanocomposite material. An approximately annular flange (15b) is formed along an outer periphery of a lens body portion (15a). The lens body portion (15a) and the flange (15b) are formed to satisfy 1<(Lt/Ft)<5 and (CA/4)≦b. “CA” is a diameter of the lens body portion (15a). “Ft” is a thickness at a center of the lens body portion (15a). “Lt” is a thickness of the flange (15b) in an optical axis direction. “R” is an outer diameter of the flange (15b). “b” is one-half of a difference between the outer diameter R and the diameter CA. Increasing the thickness of the flange (15b) increases mechanical strength of the second lens (15), thus preventing the second lens (15) from being damaged easily.

### TECHNICAL FIELD

The present invention relates to a plastic lens formed from a plastic nanocomposite material.

### BACKGROUND ART

Imaging devices, for example, a mobile phone with a camera, are provided with a lens device constituted of a taking lens and a lens barrel for accommodating the taking lens. Plastic lenses and glass lenses are known to be used as the taking lenses. In particular, the plastic lenses are superior to the glass lenses in light weight, productivity, and cost. In addition, since the plastic lenses are formed by molding, the plastic lenses can be formed into complicated shapes such as aspherical lenses. For these reasons, the plastic lenses are more commonly used than the glass lenses.

Although the plastic lenses are superior to the glass lenses in the above described features, it is difficult to increase the refractive indices of the plastic lenses to the same level as those of the glass lenses. To solve this problem, methods to form plastic lenses from plastic nanocomposite materials are known (for example, see Japanese Patent Laid-Open Publication No. 2007-211164). The plastic nanocomposite material is a plastic material such as thermoplastic polymer in which inorganic fine particles are dispersed. The plastic lenses formed from such plastic nanocomposite material have higher refractive indices than the ordinary plastic lenses, and therefore are commonly used as taking lenses for the mobile phones with cameras.

In spite of the above advantages, the plastic lenses formed from the plastic nanocomposite materials are more brittle than the ordinary plastic lenses, and therefore have lower impact resistance. In particular, a meniscus-type plastic lens whose center portion or peripheral portion is made thinner than the other portions of the lens is easily broken when stress is applied to the thinner portion.

In view of the foregoing, an object of the present invention is to provide plastic lenses, formed from plastic nanocomposite materials, more resistant to breakage than the conventional plastic lenses.

### DISCLOSURE OF INVENTION

In order to achieve the above objects and other objects, a plastic lens of the present invention has a lens body portion and a flange formed along an outer periphery of the lens body portion. A diameter CA of the lens body portion, a center thickness Ft of the lens body portion, a thickness Lt of the flange in an optical axis direction, and a length b that is one-half of a difference between an outer diameter of the flange and the diameter CA satisfy 1<(Lt/Ft)<5 and (CA/4)≦b. The plastic lens is formed from a plastic nanocomposite material containing inorganic fine particles and thermoplastic polymer. The thermoplastic polymer has a functional group in at least one of a main chain end and a side chain. The functional group is chemically bonded to at least one of the inorganic fine particles.

It is preferable that chamfering is performed to a corner portion of the flange. Thereby chipping of the corner portion of the flange is avoided.

It is preferable that the thickness Lt is larger than a thickness of the lens body portion at an outermost periphery of the diameter CA.

The plastic lens of the present invention is formed such that the lens body portion and the flange satisfy 1<(Lt/Ft)<5 and (CA/4)≦b. Thereby mechanical strength of the plastic lens is increased. As a result, the present invention prevents the plastic lens from being damaged easily even if the plastic lens is formed from the plastic nanocomposite material.

### BRIEF DESCRIPTION OF DRAWINGS

FIG. 1 is a section view of a lens device;

FIG. 2 is a section view of a convex meniscus lens formed from a nanocomposite material;

FIG. 3 is a section view of a mold for forming a lens from the nanocomposite material; and

FIG. 4 is a section view of a convex meniscus lens of another embodiment.

### BEST MODE FOR CARRYING OUT THE INVENTION

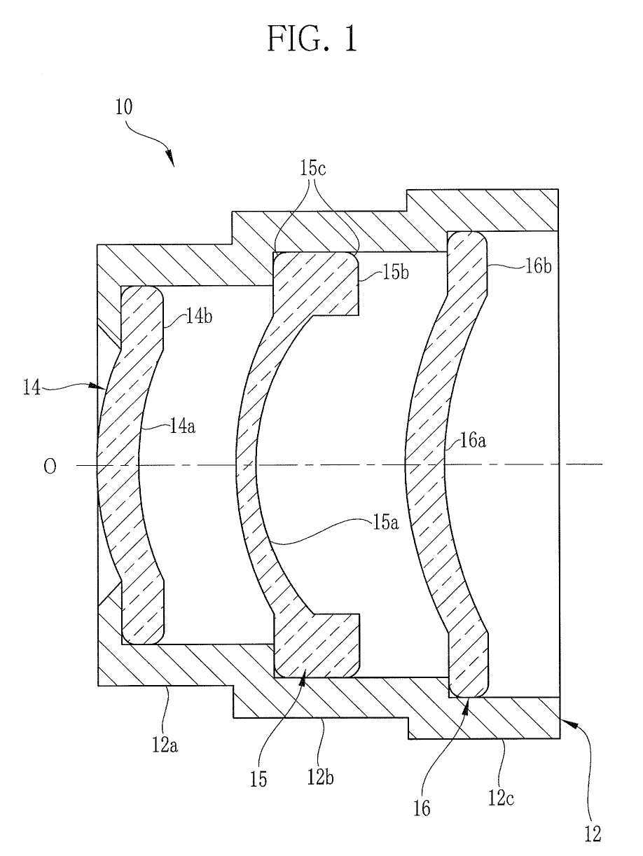

In FIG. 1, a lens device 10 is provided, for example, in a mobile phone with a camera (not shown). The lens device 10 is constituted of a lens barrel 12 and first to third lenses 14 to 16. The lens barrel 12 is formed from plastic such as polycarbonate or liquid crystal polymer, aluminum, or the like. The lens barrel 12 is constituted of a first barrel section 12a, a second barrel section 12b, and a third barrel section 12c molded in one-piece. The first to the third barrel sections 12a to 12c differ from each other in diameter. The first barrel section 12a in a forward portion of the lens barrel 12 has the smallest diameter. The third barrel section 12c in the rear of the lens barrel 12 has the largest diameter.

The first to the third lenses 14, 15, and 16 are attached and fixed to the first to the third barrel sections 12a, 12b, and 12c, respectively. The first lens 14 is a convex glass lens. The second lens 15 is a concave meniscus plastic lens. The third lens 16 is a convex plastic lens. The first lens 14 is constituted of a lens body portion 14a and a flange 14b. The second lens 15 is constituted of a lens body portion 15a and a flange 15b. The third lens 16 is constituted of a lens body portion 16a and a flange 16b. The flanges 14b to 16b have approximately annular shapes and are provided along outer peripheries (rims) of the lens body portions 14a to 16a, respectively. Of the lens body portions 14a to 16a, a center portion of the lens body portion 15a of the convex meniscus type is made thinner than peripheral portions thereof. The flanges 14b to 16b are fitted into the first to third barrel sections 12a to 12c, respectively. Thus, the lens body portions 14a to 16a are fixed inside the lens barrel 12.

Of the second and the third lenses 15 and 16 that are plastic lenses, the second lens 15 is formed from plastic nanocomposite material (hereinafter simply referred to as nanocomposite material) because a high refractive index is required. On the other hand, the third lens 16 is formed from ordinary plastic material because the high refractive index is not required.

The nanocomposite material is an organic-inorganic composite material containing inorganic fine particles and thermoplastic polymer. The thermoplastic polymer has a functional group in at least one of a main chain and a side chain. The functional group is chemically bonded with at least one of the inorganic fine particles. More specifically, in the nanocomposite material, the inorganic fine particles are dispersed in the thermoplastic polymer. It should be noted that one or more kinds of inorganic fine particles may be dispersed in the plastic material. Hereinafter, examples of the thermoplastic polymer and inorganic fine particles used for forming the nanocomposite material are described.

[Thermoplastic Polymer]

A thermoplastic polymer (thermoplastic resin) effectively used for production of a plastic lens of the present invention has a functional group, in at least one of a main chain end (polymer chain end) or a side chain, capable of forming any kind of chemical bond with inorganic fine particles.

Preferable examples of such thermoplastic polymer include:
(1) a thermoplastic polymer having at least one of functional groups in a side chain, and such functional group is selected from the following,

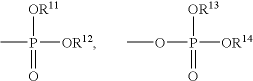

[Each of R¹¹, R¹², R¹³, and R¹⁴ can be any of a hydrogen atom, a substituted or unsubstituted alkyl group, a substituted or unsubstituted alkenyl group, a substituted or unsubstituted alkynyl group, or a substituted or unsubstituted aryl group], —SO₃H, —OSO₃H, —CO₂H, and —Si(OR¹⁵)ₘ₁R¹⁶₃₋ₘ₁ [each of R¹⁵ and R¹⁶ is a hydrogen atom, a substituted or unsubstituted alkyl group, a substituted or unsubstituted alkenyl group, a substituted or unsubstituted alkynyl group or a substituted or unsubstituted aryl group, and m1 is an integer from 1 to 3];
(2) a thermoplastic polymer having at least one of functional groups in at least a part of a main chain end, and such functional group is selected from the following,

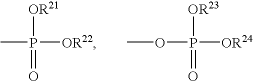

[Each of R²¹, R²², R²³, and R²⁴ can be any of a hydrogen atom, a substituted or unsubstituted alkyl group, a substituted or unsubstituted alkenyl group, a substituted or unsubstituted alkynyl group, or a substituted or unsubstituted aryl group], —SO₃H, —OSO₃H, —CO₂H, and —Si(OR²⁵)ₘ₂R²⁶₃₋ₘ₂ [each of R²⁵ and R²⁶ is a hydrogen atom, a substituted or unsubstituted alkyl group, a substituted or unsubstituted alkenyl group, a substituted or unsubstituted alkynyl group or a substituted or unsubstituted aryl group, m2 is an integer from 1 to 3]; and
(3) a block copolymer composed of a hydrophobic segment and a hydrophilic segment.
Hereinafter, the thermoplastic polymers (1) to (3) are detailed.

Thermoplastic Polymer (1)

The thermoplastic polymer (1) used in the present invention has a functional group, in a side chain, capable of forming a chemical bond with inorganic fine particles. The examples of the “chemical bond” used herein include, for example, a covalent bond, an ionic bond, a coordinate bond, and a hydrogen bond. In a case where a thermoplastic polymer (1) has plural functional groups, each functional group may form a different chemical bond with inorganic fine particles. Whether a functional group is capable of forming a chemical bond with inorganic particles is determined by the presence of a chemical bond between the functional group and the inorganic fine particles when the thermoplastic polymer and the inorganic fine particles are dispersed in an organic solvent. All or a part of the functional groups of the thermoplastic polymer may form chemical bonds with inorganic fine particles.

By forming the chemical bonds between the inorganic fine particles and the functional group capable of forming the chemical bond with the inorganic fine particles, the inorganic fine particles are stably dispersed in the thermoplastic polymer. Such functional group is selected from

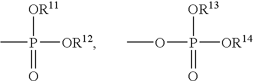

[Each of R¹¹, R¹², R¹³, and R¹⁴ can be any of a hydrogen atom, a substituted or unsubstituted alkyl group, a substituted or unsubstituted alkenyl group, a substituted or unsubstituted alkynyl group, or a substituted or unsubstituted aryl group], —SO₃H, —OSO₃H, —CO₂H, or —Si(OR¹⁵)ₘ₁R¹⁶₃₋ₘ₁ each of R¹⁵ and R¹⁶ is a hydrogen atom, a substituted or unsubstituted alkyl group, a substituted or unsubstituted alkenyl group, a substituted or unsubstituted alkynyl group or a substituted or unsubstituted aryl group, and m1 is an integer from 1 to 3].

The alkyl group has preferably from one to 30 carbon atoms, and more preferably from one to 20 carbon atoms, and examples thereof include a methyl group, an ethyl group, and an n-propyl group. The substituted alkyl group includes, for example, an aralkyl group. The aralkyl group has preferably from 7 to 30 carbon atoms, and more preferably from 7 to 20 carbon atoms, and examples thereof include a benzyl group, and a p-methoxybenzyl group. The alkenyl group has preferably from 2 to 30 carbon atoms, and more preferably from 2 to 20 carbon atoms, and examples thereof include a vinyl group and a 2-phenylethenyl group. The alkynyl group has preferably from 2 to 20 carbon atoms, and more preferably from 2 to 10 carbon atoms, and examples thereof include an ethynyl group, and a 2-phenylethynyl group. The aryl group has preferably from 6 to 30 carbon atoms, and more preferably from 6 to 20 carbon atoms, and examples thereof include a phenyl group, a 2, 4, 6-tribromophenyl group, and a 1-naphthyl group. The aryl group used herein includes a heteroaryl group. Examples of substituents for the alkyl group, the alkenyl group, the alkynyl group, and the aryl group include a halogen atom (for example, a fluorine atom, a chlorine atom, a bromine atom, and an iodine atom) and an alkoxy group (for example, a methoxy group or an ethoxy group) in addition to the above-described alkyl group, the alkenyl group, the alkynyl group, and the aryl group. Preferable number of atoms, functional groups, and substituents for the R¹⁵ and R¹⁶ are the same as those for R¹¹, R¹², R¹³, and R¹⁴. The m1 is preferably 3.

Of the above functional groups, preferable are

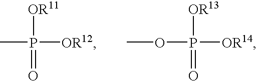

—SO₃H, —CO₂H, or —Si (OR¹⁵)ₘ₁R¹⁶₃₋ₘ₁. More preferable functional groups are

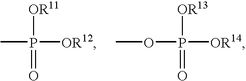

or —CO₂H. Especially preferable functional groups are

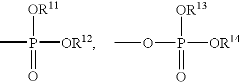

It is especially preferable that the thermoplastic polymer used in the present invention is a copolymer having a repeating unit represented by a general formula (1) below. Such copolymer is synthesized by copolymerization of vinyl monomers represented by a general formula (2) below.

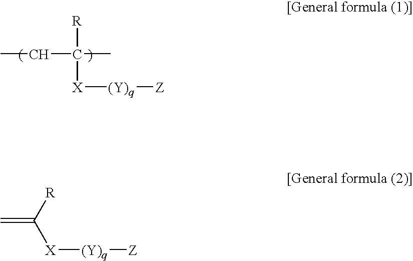

In the general formulae (1) and (2), “R” represents one of a hydrogen atom, a halogen atom, and a methyl group. “X” represents a bivalent linking group selected from a group consists of —CO₂—, —COO—, —CONH—, —OCONH—, —OCOO—, —O—, —S—, —NH—, and a substituted or unsubstituted arylene group. It is more preferable that “X” is —CO₂— or a p-phenylene group.

“Y” represents a bivalent linking group having 1 to 30 carbon atoms. The number of the carbon atoms is preferably 1 to 20, more preferably 2 to 10, and furthermore preferably 2 to 5. More specifically, an alkylene group, an alkyleneoxy group, an alkyleneoxycarbonyl group, an arylene group, an aryleneoxy group, an aryleneoxycarbonyl group, and a combination of the above groups may be used. In particular, the alkylene group is preferable.

“q” represents an integer from zero to 18, more preferably zero to 10, furthermore preferably from zero to 5, and especially preferably zero or one.

“Z” represents a functional group selected from a group consists of

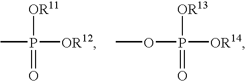

, —SO₃H, —OSO₃H, —CO₂H and —Si(OR¹⁵)ₘ₁R¹⁶₃₋ₘ₁. Of these, preferable functional groups are

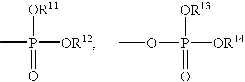

More preferable functional group is

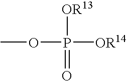

Here, definitions and specific examples of R¹¹, R¹², R¹³, R¹⁴, R¹⁵, R¹⁶ and m1 are the same as those of the R¹¹, R¹², R¹³, R¹⁴, R¹⁵, R¹⁶ and m1 previously described, except that each of R¹¹, R¹², R¹³, R¹⁴, R¹⁵, and R¹⁶ is a hydrogen atom or an alkyl group.

Hereinafter, specific examples of monomers represented by the general formula (2) are described. However, monomers usable in the present invention are not limited to these examples.

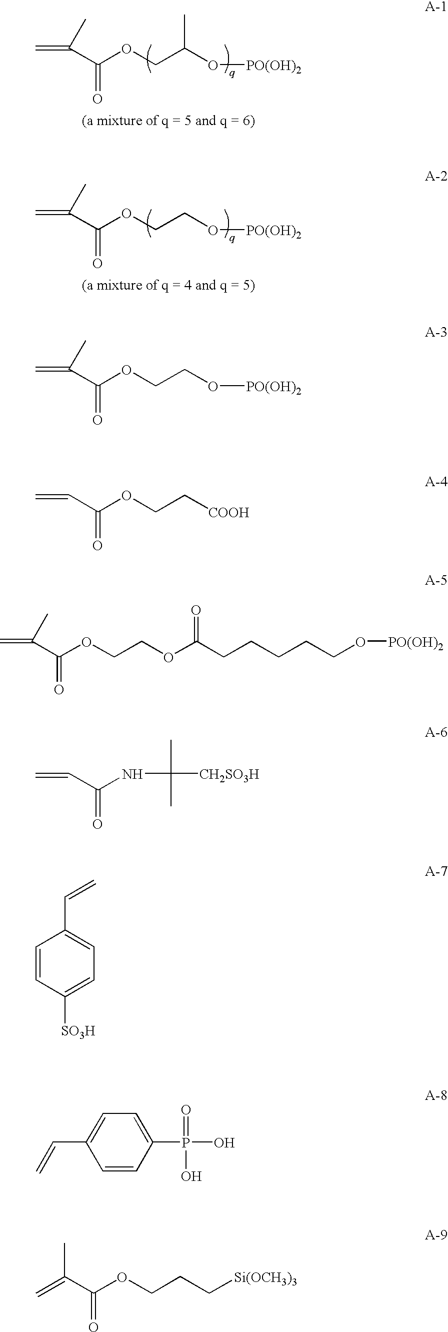

Other kinds of monomers copolymerizable with the monomer represented by the above general formula (2) are described in pages one to 483, in chapter 2 of “Polymer Handbook 2^{nd} ed.”, J. Brandrup, Wiley Interscienece (1975).

Specifically, for example, compounds having one addition-polymerizable unsaturated bond selected from styrene derivatives, 1-vinylnaphthalene, 2-vinylnaphthalene, vinylcarbazole, acrylic acid, methacrylic acid, acrylic esters, methacrylic esters, acrylamides, methacrylamides, allyl compounds, vinyl ethers, vinyl esters, dialkyl itaconates, and dialkyl esters or monoalkyl esters of fumaric acid, can be exemplified.

Examples of the styrene derivative include styrene, 2, 4, 6-tribromostyrene, 2-phenylstyrene.

Examples of the acrylic esters include methyl acrylate, ethyl acrylate, propyl acrylate, n-butyl acrylate, tert-butyl acrylate, chloroethyl acrylate, 2-hydroxyethyl acrylate, trimethylolpropane monoacrylate, benzyl acrylate, methoxybenzyl acrylate, furfuryl acrylate, and tetrahydrofurfuryl acrylate.

Examples of the methacrylic esters include methyl methacrylate, ethyl methacrylate, propyl methacrylate, butyl methacrylate, tert-butyl methacrylate, chloroethyl methacrylate, 2-hydroxyethyl methacrylate, trimethylolpropane monomethacrylate, benzyl methacrylate, methoxybenzyl methacrylate, furfuryl methacrylate, and tetrahydrofurfuryl methacrylate.

Examples of the acrylamides include acrylamide, N-alkyl acrylamide (with an alkyl group having 1 to 3 carbon atoms, such as a methyl group, an ethyl group, or a propyl group), N,N-dialkyl acrylamide (with an alkyl group having 1 to 6 carbon atoms), N-hydroxyethyl-N-methyl acrylamide and N-2-acetamideethyl-N-acetyl acrylamide.

Examples of the methacrylamides include methacrylamide, N-alkyl methacrylamide (with an alkyl group having 1 to 3 carbon atoms, such as a methyl group, an ethyl group, or a propyl group), N,N-dialkyl methacrylamide (with an alkyl group having 1 to 6 carbon atoms), N-hydroxyethyl-N-methyl methacrylamide and N-2-acetamideethyl-N-acetyl methacrylamide.

Examples of the allyl compounds include allyl esters (for example, allyl acetate, allyl caproate, allyl caprylate, allyl laurate, allyl palmitate, allyl stearate, allyl benzoate, allyl acetoacetate and allyl lactate), and allyl oxyethanol.

Examples of the vinyl ethers include alkyl vinyl ethers with an alkyl group having 1 to 10 carbon atoms, such as hexyl vinyl ether, octyl vinyl ether, decyl vinyl ether, ethylhexyl vinyl ether, methoxyethyl vinyl ether, ethoxyethyl vinyl ether, chloroethyl vinyl ether, 1-methyl-2,2-dimethylpropyl vinyl ether, 2-ethylbutyl vinyl ether, hydroxyethyl vinyl ether, diethylene glycol vinyl ether, dimethylaminoethyl vinyl ether, diethylaminoethyl vinyl ether, butylaminoethyl vinyl ether, benzyl vinyl ether and tetrahydrofurfuryl vinyl ether.

Examples of the vinyl esters include vinyl butyrate, vinyl isobutyrate, vinyl trimethyl acetate, vinyl diethyl acetate, vinyl pivalate, vinyl caproate, vinyl chloroacetate, vinyl dichloroacetate, vinyl methoxyacetate, vinyl butoxyacetate, vinyl lactate, vinyl-β-phenyl butylate and vinyl cyclohexyl carboxylate.

Examples of the dialkyl itaconates include dimethyl itaconate, diethyl itaconate and dibutyl itaconate. Examples of dialkyl esters or monoalkyl esters of the fumaric acid include dibutyl fumarate.

In addition, crotonic acid, itaconic acid, acrylonitrile, methacrylonitrile, maleonitrile and the like can be exemplified.

The thermoplastic polymer (1) used in the present invention has a number average molecular weight of preferably from 1,000 to 500,000, more preferably from 3,000 to 300,000, and especially preferably from 10,000 to 100,000. In a case where the thermoplastic polymer (1) has the number average molecular weight of at most 500,000, processability of the thermoplastic polymer (1) improves, and where it is at least 1,000, mechanical strength increases.

The “number average molecular weight” used herein is a polystyrene equivalent molecular weight based on detection by a differential refractometer of a GPC analyzer with columns of TSK gel GMHXL, TSK gel G4000HxL, and TSK gel G2000HxL (trade names of Tosoh Corporation) using tetrahydrofuran as a solvent.

In the thermoplastic polymer (1) used in the present invention, the average number of the functional group that bonds to the inorganic fine particles, per polymer chain is preferably from 0.1 to 20, more preferably from 0.5 to 10, and especially preferably from 1 to 5. Gelation and an increase in viscosity in a solution state caused by coordination of the thermoplastic polymer (1) to plural inorganic fine particles is prevented where the average number of the functional group is at most 20 per polymer chain. The inorganic fine particles are dispersed stably where the average number of the functional group per polymer chain is at least 0.1.

A glass transition temperature of the thermoplastic polymer (1) used in the present invention is preferably 80° C. to 400° C., and more preferably 130° C. to 380° C. An optical component having sufficient heat resistance is produced from a thermoplastic polymer having the glass transition temperature of at least 80° C. Processability is improved by using the thermoplastic polymer having the glass transition temperature of at most 400° C.

Rayleigh scattering is likely to occur where there is a significant difference between a refractive index of the thermoplastic polymer (1) and a refractive index of the inorganic fine particles. As a result, the amount of the inorganic fine particles to be dispersed in the thermoplastic polymer (1) needs to be reduced to maintain transparency of a molded product. In a case where the refractive index of the thermoplastic polymer (1) is approximately 1.48, the transparent molded product having the refractive index in a level of 1.60 can be provided. To achieve the refractive index of at least 1.65, the refractive index of the thermoplastic polymer (1) used in the present invention is preferably at least 1.55, and more preferably at least 1.58. These refractive indices are measured at 589 nm wavelength at 22° C.

The thermoplastic polymer (1) used in the present invention has a light transmittance of preferably at least 80%, more preferably at least 85%, and especially preferably at least 88%, at 589 nm wavelength with the thickness of 1 mm.

Hereinafter, preferable specific examples of the thermoplastic polymer (1) that can be used in the present invention are described, but the thermoplastic polymer that can be used in the present invention is not limited to the following examples.

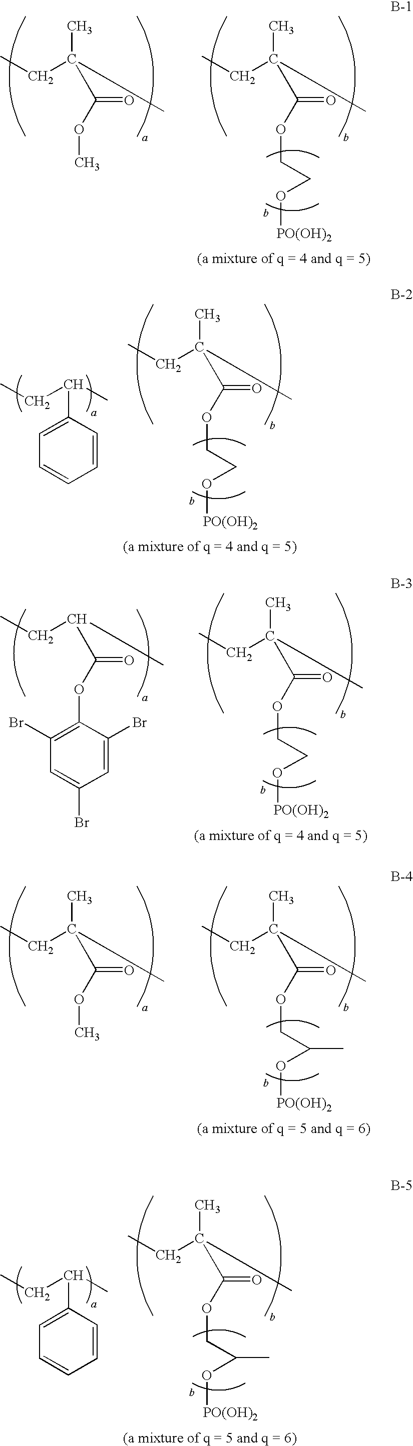

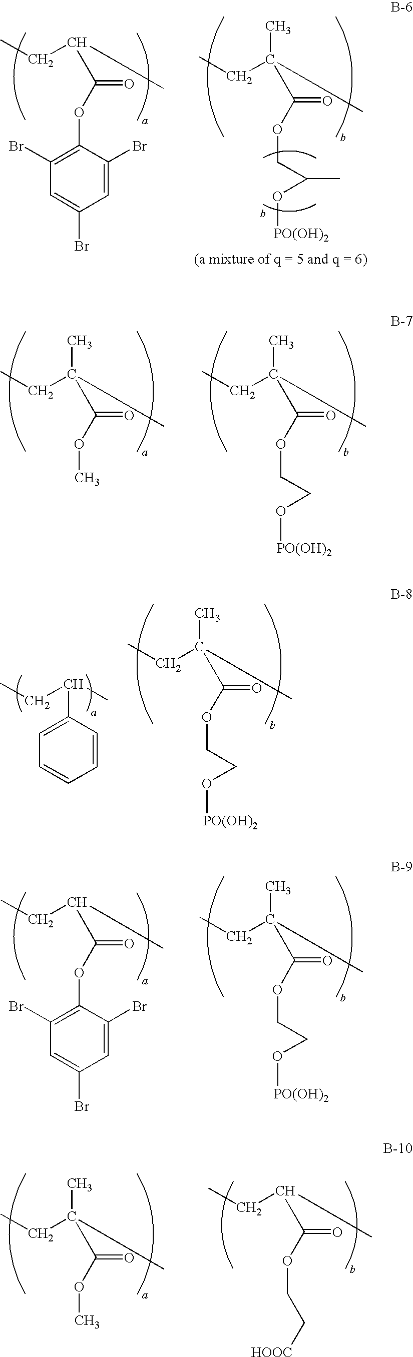

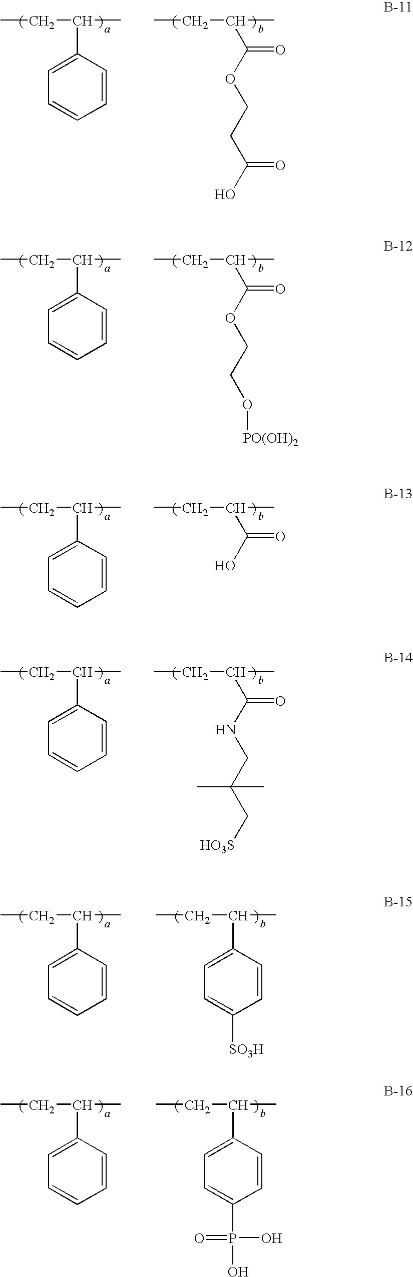

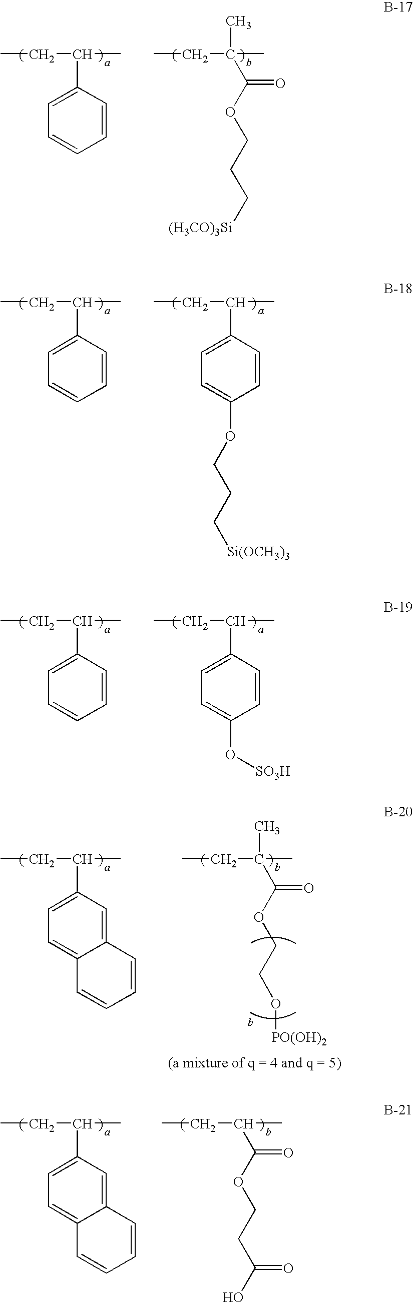

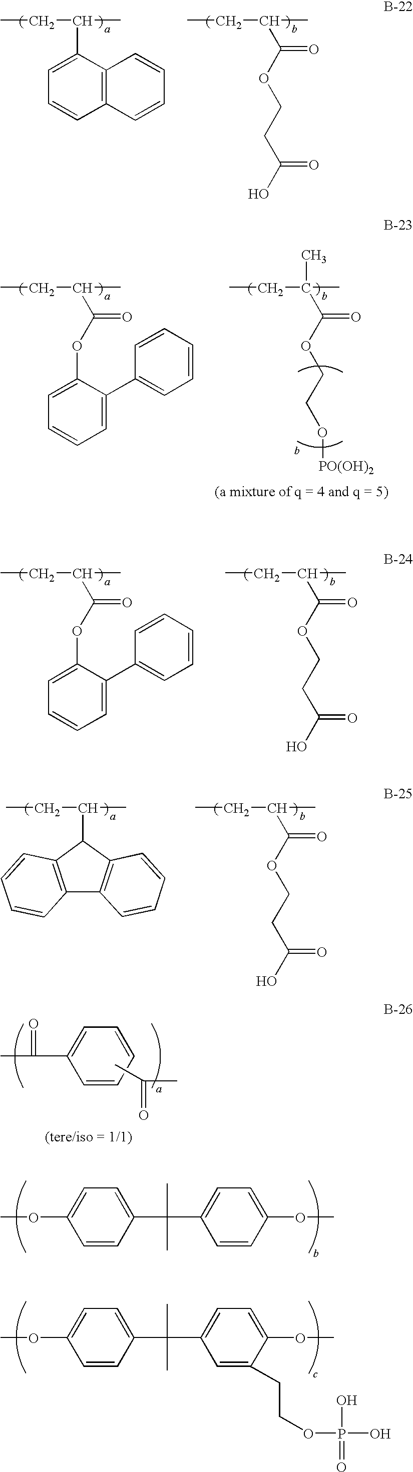

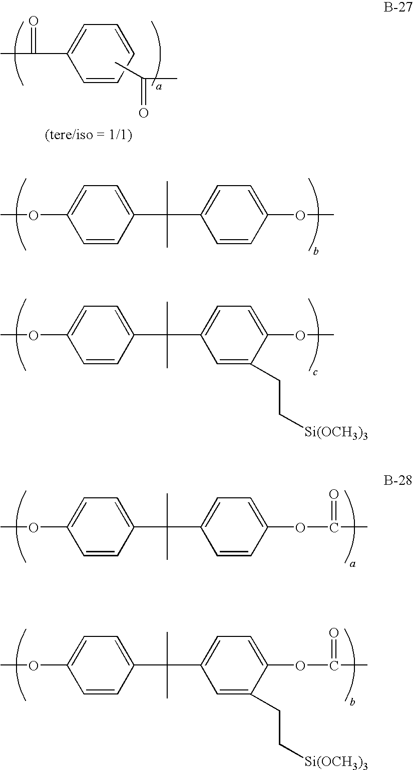

The thermoplastic polymer (1) may be one kind or a mixture of two or more kinds of the above-mentioned thermoplastic polymers. In addition, the thermoplastic polymer (1) may be mixed with a thermoplastic polymer (2) and/or a thermoplastic polymer (3).

Thermoplastic Polymer (2)

The thermoplastic polymer (2) used in the present invention has a functional group, in at least a part of a main chain end, capable of forming a chemical bond with inorganic fine particles. The functional group may be present in one or both of the main chain ends. However, it is preferable that the functional group is present only in one of the main chain ends. Plural functional groups may be present in the main chain end. The “main chain end” refers to a moiety of the polymer excluding a repeating unit and a structure sandwiched between repeating units. The “chemical bond” is considered similar to that in the above-described thermoplastic polymer (1).

The functional group capable of forming a chemical bond with inorganic fine particles is a selected one of

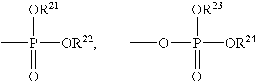

[Each of R²¹, R²², R²³, and R²⁴ can be any of a hydrogen atom, a substituted or unsubstituted alkyl group, a substituted or unsubstituted alkenyl group, a substituted or unsubstituted alkynyl group, or a substituted or unsubstituted aryl group], —SO₃H, —OSO₃H, —CO₂H, and —Si(OR²⁵)ₘ₂R²⁶₃₋ₘ₂ [each of R²⁵ and R²⁶ is a hydrogen atom, a substituted or unsubstituted alkyl group, a substituted or unsubstituted alkenyl group, a substituted or unsubstituted alkynyl group or a substituted or unsubstituted aryl group, m2 is an integer from 1 to 3].

In the case each of R²¹, R²², R²³, R²⁴, R²⁵, and R²⁶ is a substituted or unsubstituted alkyl group, a substituted or unsubstituted alkenyl group, a substituted or unsubstituted alkynyl group, or a substituted or unsubstituted aryl group, preferable number of carbon atoms, functional groups, and substituents for R²¹, R²², R²³, R²⁴, R²⁵, and R²⁶ are the same as those for R¹¹, R¹², R¹³, R¹⁴, (R¹⁵, and R¹⁶). It is preferable that m2 is 3.

Of the above functional groups, preferable are

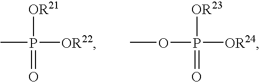

—SO₃H, —CO₂H, and —Si(OR²⁵)ₘ₂R²⁶₃₋ₘ₂. More preferable functional groups are

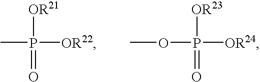

—SO₃H, and —CO₂H. Especially preferable functional groups are

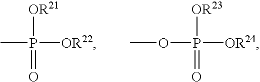

and —SO₃H.

A basic skeleton of the thermoplastic polymer (2) in the present invention is not particularly limited. A well known polymer structure such as that of poly(meth)acrylic ester, polystyrene, polyvinyl carbazole, polyarylate, polycarbonate, polyurethane, polyimide, polyether, polyether sulfone, polyether ketone, polythioether, cycloolefin polymer, and cycloolefin copolymer can be employed. A vinyl polymer, a polyarylate and an aromatic group-containing polycarbonate are preferable, and a vinyl polymer is more preferable. Specific examples are the same as those described for the thermoplastic polymer (1).

The thermoplastic polymer (2) used in the present invention has a refractive index of preferably at least 1.50, more preferably at least 1.55, further preferably at least 1.60, and especially preferably at least 1.65. The refractive index used herein is measured using an Abbe's refractometer (a product of Atago, Model: DR-M4) with incident light of 589 nm wavelength.

The thermoplastic polymer (2) used in the present invention has a glass transition temperature of preferably from 50° C. to 400° C., and more preferably from 80° C. to 380° C. In a case where the thermoplastic polymer (2) has a glass transition temperature of at least 50° C., heat resistance increases. In a case where the thermoplastic polymer (2) has a glass transition temperature of at most 400° C., processing becomes facilitated.

The thermoplastic polymer (2) used in the present invention has a light transmittance of preferably at least 80%, and more preferably at least 85%, at 589 nm wavelength with the thermoplastic polymer thickness of 1 mm.

The thermoplastic polymer (2) used in the present invention has a number average molecular weight of preferably from 1,000 to 500,000. The number average molecular weight is preferably from 3,000 to 300,000, and more preferably from 5,000 to 200,000, and especially preferably from 10,000 to 100,000. With the use of the thermoplastic polymer (2) having the number average molecular weight of at least 1,000, mechanical strength increases. With the use of the thermoplastic polymer (2) having the number average molecular weight of at most 500,000, processability of the thermoplastic polymer improves.

A method of introducing the functional group into the main chain end is not particularly limited. For example, as described in Chapter 3 Terminal Reactive Polymer of “New Polymer Experimental Studies 4, Synthesis and Reaction of Polymer (3) Reaction and Decomposition of Polymer” edited by the Society of Polymer Science, Japan, the functional group may be introduced at the time of polymerization, or after polymerization. In the case the functional group is introduced after polymerization, the polymer is isolated and then subjected to terminal functional group transformation or main chain decomposition. It is also possible to use polymer reactions such as a method of synthesizing polymer by polymerization using an initiator, a terminator, a chain transfer agent or the like having a functional group and/or a protected functional group, and a method in which a phenol terminal of polycarbonate synthesized from, for example, bisphenol A is modified with a reacting agent containing a functional group. For example, radical polymerization of vinyl monomer by a chain transfer method using a sulfur-containing chain transfer agent, described in pages 110-112 of “New Polymer Experimental Studies 2, Synthesis and Reaction of Polymer (1) Synthesis of Addition-Type Polymer” edited by the Society of Polymer Science, Japan; living cationic polymerization using a functional group-containing initiator and/or a functional group-containing terminator, described in pages 255-256 of “New Polymer Experimental Studies 2, Synthesis and Reaction of Polymer (1) Synthesis of Addition-Type Polymer” edited by the Society of Polymer Science, Japan; and ring-opening metathesis polymerization using a sulfur-containing chain transfer agent, described in pages 7020-7026 of Macromolecules, vol. 36, (2003) can be exemplified.

Preferable specific examples of the thermoplastic polymer (2) that can be used in the present invention are described in the following illustrated compounds P-1 to P-22, but the thermoplastic polymer (2) is not limited to such examples. The structure in parentheses shows a repeating unit, and x and y of the repeating unit represent a copolymerization ratio (molar ratio).

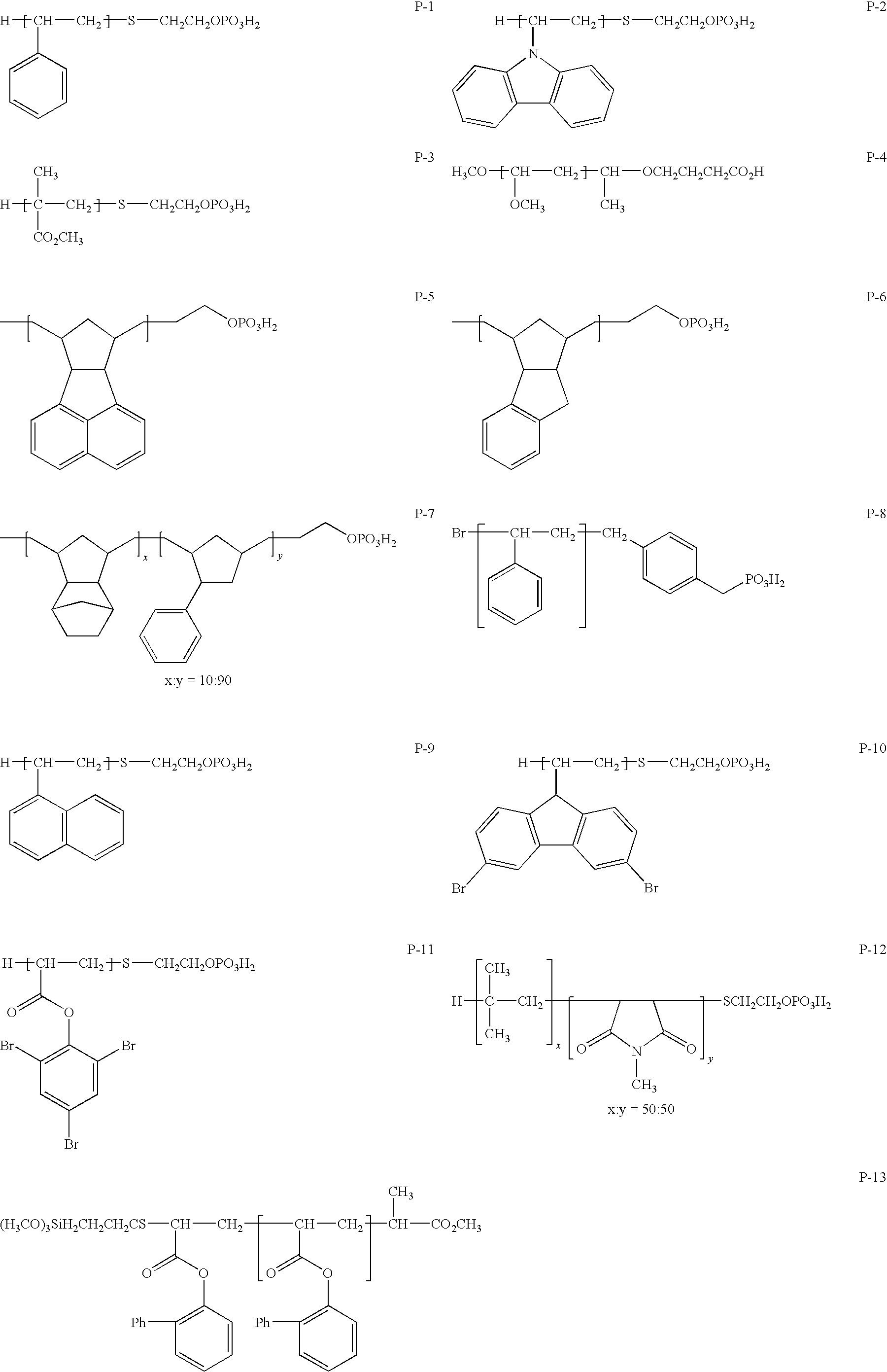

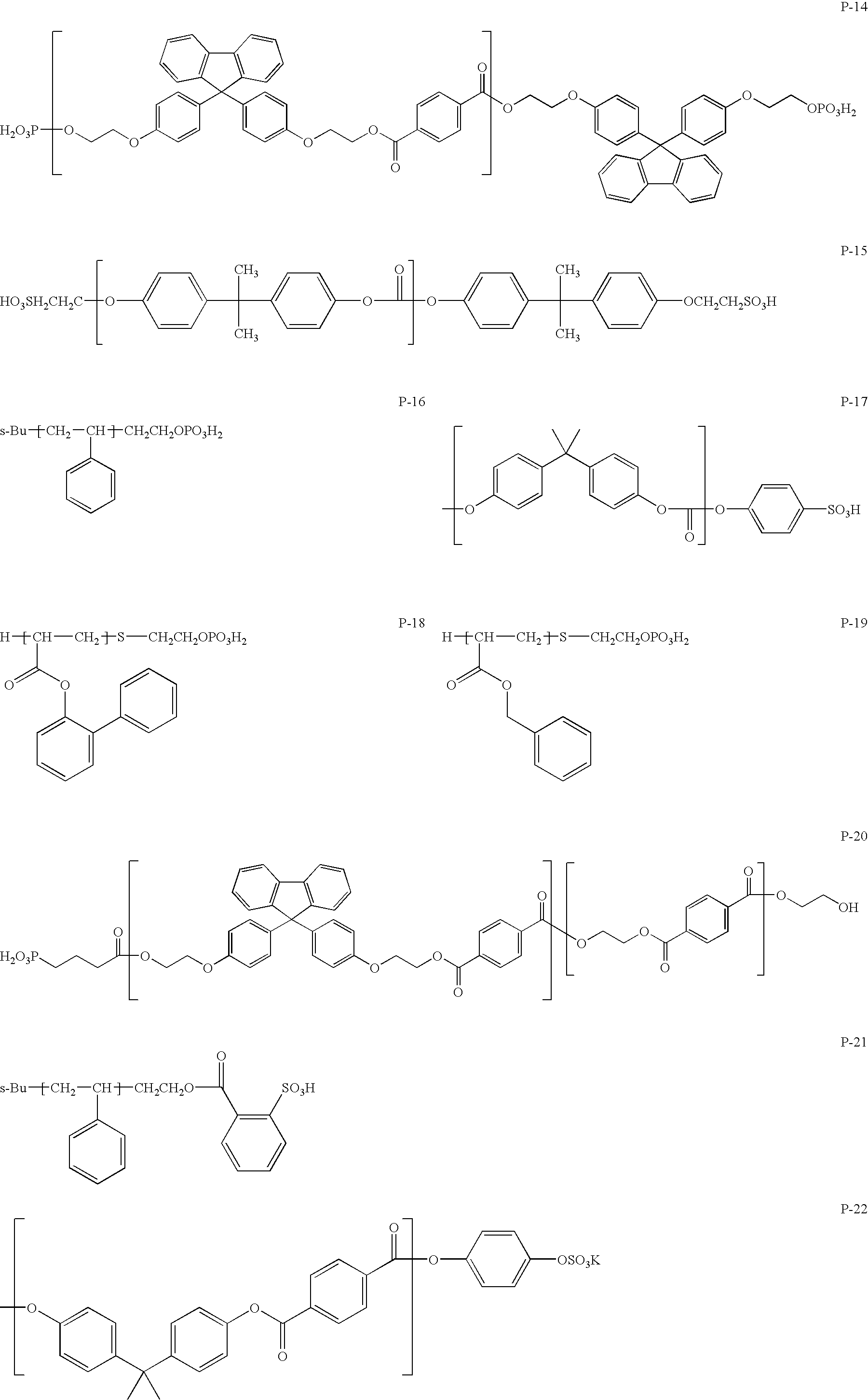

One kind or a mixture of two or more kinds of the above-mentioned thermoplastic polymers (2) may be used. These thermoplastic polymers (2) may contain other copolymerization components.

Thermoplastic Polymer (3)

A thermoplastic polymer (3) used in the present invention is a block copolymer composed of a hydrophobic segment (A) and a hydrophilic segment (B).

The hydrophobic segment(s) (A) make up the polymer that is not soluble in water nor methanol. The hydrophilic segment (s) (B) make up the polymer soluble in at least one of water and methanol. Types of the block copolymer include AB type, B¹AB² type, and A¹BA² type. In the B¹AB² type, two hydrophilic segments B¹ and B² may be the same or different. In the A¹BA² type, two hydrophobic segments A¹ and A² may be the same or different. In view of dispersibility, the block copolymers of the AB type or the A¹BA² type are preferable. In view of production suitability, the AB type or the ABA type (the A¹BA² type in which the two hydrophobic segments A¹ and A² are the same) is preferable, and the AB type is especially preferable.

Each of the hydrophobic segment (A) and the hydrophilic segment (B) may be selected from well known polymers such as vinyl polymer obtained by polymerization of vinyl monomers, polyether, ring-opening metathesis polymerization polymer and condensation polymer (polycarbonate, polyester, polyamide, polyether ketone, polyether sulfone, and the like). In particular, vinyl polymer, ring-opening metathesis polymerization polymer, polycarbonate, and polyester are preferable. In view of production suitability, vinyl polymer is more preferable.

Examples of vinyl monomer (a) forming the hydrophobic segment (A) include the following: acrylic esters, methacryl esters (an ester group is a substituted or unsubstituted aliphatic ester group or a substituted or unsubstituted aromatic ester group, for example, a methyl group, a phenyl group, a naphthyl group, or the like);

acryl amides, methacryl amides, more specifically, N-monosubstituted acrylamides, N-disubstituted acrylamides, N-monosubstituted methacrylamides, N-disubstituted methacrylamides (substituents of a monosubstitution product and disubstitution product include a substituted or unsubstituted aliphatic group, and a substituted or unsubstituted aromatic group, for example, a methyl group, a phenyl group, a naphthyl group, or the like);

olefins, more specifically, dicyclopentadiene, norbornene derivative, ethylene, propylene, 1-buten, 1-penten, vinyl chloride, vinylidene chloride, isoprene, chloroprene, butadiene, 2,3-dimethylbutadiene, and vinyl carbazole; styrenes, more specifically, styrene, methylstyrene, dimethylstyrene, trimethylstyrene, ethylstyrene, isopropylstyrene, chloromethylstyrene, methoxystyrene, acetoxystyrene, chlorostyrene, dichlorostyrene, bromostyrene, tribromostyrene, and vinylbenzoic acid methyl ester; and

vinyl ethers, more specifically, methyl vinyl ether; butyl vinyl ether, phenyl vinyl ether, and methoxyethyl vinyl ether; other monomers such as butyl crotonate, hexyl crotonate, dimethyl itaconate, dibutyl itaconate, diethyl maleate, dimethyl maleate, dibutyl maleate, diethyl fumarate, dimethyl fumarate, dibutyl fumarate, methylvinyl ketone, phenylvinyl ketone, methoxyethyl vinyl ketone, N-vinyl oxazolidone, N-vinyl pyrrolidone, vinylidene chloride, methylene malononitrile, vinylidene, diphenyl-2-acryloyloxyethyl phosphate, diphenyl-2-methacryloyloxyethyl phosphate, dibutyl-2-acryloyloxyethyl phosphate, and dioctyl-2-methacryloyloxyethyl phosphate.

In particular, acrylic esters and methacrylic esters whose ester group is an unsubstituted aliphatic group, or a substituted or unsubstituted aromatic group; N-monosubstituted acrylamides, N-disubstituted acrylamides, N-monosubstituted methacrylamides and N-disubstituted methacrylamides whose substituent is an unsubstituted aliphatic group, or substituted or unsubstituted aromatic group; and styrenes are preferable. Acrylic esters and methacryl esters whose ester group is substituted or unsubstituted aromatic group; and styrenes are more preferable.

Examples of the vinyl monomer (b) forming the hydrophilic segment (B) include the following: acrylic acid, methacrylic acid, acrylic esters and methacrylic esters having a hydrophilic substituent at an ester moiety; styrenes having a hydrophilic substituent at an aromatic ring; vinyl ethers, acrylamides, methacryl amides, N-monosubstituted acrylamides, N-disubstituted acrylamides, N-monosubstituted methacrylamides, and N-disubstituted methacrylamides having a hydrophilic substituent.

The hydrophilic substituent preferably has a functional group selected from a group consists of

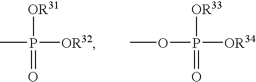

[Each of R³¹, R³², R³³, and R³⁴ can be any of a hydrogen atom, a substituted or unsubstituted alkyl group, a substituted or unsubstituted alkenyl group, a substituted or unsubstituted alkynyl group, or a substituted or unsubstituted aryl group], —SO₃H, —OSO₃H, —CO₂H, —OH, and —Si(OR³⁶)ₘ₃R³⁶₃₋ₘ₃ [each of R³⁵ and R³⁶ is a hydrogen atom, a substituted or unsubstituted alkyl group, a substituted or unsubstituted alkenyl group, a substituted or unsubstituted alkynyl group, or a substituted or unsubstituted aryl group, m3 is an integer from 1 to 3]. In a case where each of R³¹, R³², R³³, R³⁴, R³⁵, and R³⁶ is a substituted or unsubstituted alkyl group, a substituted or unsubstituted alkenyl group, a substituted or unsubstituted alkynyl group, or a substituted or unsubstituted aryl group, preferable number of atoms, functional groups, and substituents for R³¹, R³², R³³, R³⁴, R³⁵, and R³⁶ are the same as those for R¹¹, R¹², R¹³, R¹⁴, (R¹⁵, and R¹⁶). The m3 is preferably 3.

The functional group is preferably

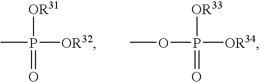

—CO₂H, or —Si(OR³⁵)ₘ₃R³⁶₃₋ₘ₃, and more preferably,

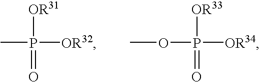

and —CO₂H,

and especially preferably,

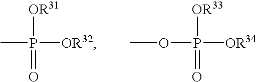

In the invention, it is preferable that the block copolymer has a functional group selected from

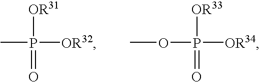

—SO₃H, —OSO₃H, —CO₂H, —OH, and —Si(OR³⁵)m₃R³⁶₃₋ₘ₃, and a content of the functional group is at least 0.05 mmol/g and at most 5.0 mmol/g.

In particular, the hydrophilic segment (B) is preferably acrylic acid, methacrylic acid, acrylic ester or methacrylic ester with a hydrophilic substituent at the ester moiety, and styrene having a hydrophilic substituent in an aromatic ring.

The hydrophobic segment (A) formed of the vinyl, monomer (a) may also contain the vinyl monomer (b) within a range of not changing the hydrophobic property. It is preferable that a molar ratio between the vinyl monomer (a) and the vinyl monomer (b) contained in the hydrophobic segment (A) is 100:0 to 60:40.

The hydrophilic segment (B) formed of the vinyl monomer (b) may also contain the vinyl monomer (a) within a range of not changing the hydrophilic property. It is preferable that a molar ratio between the vinyl monomer (b) and the vinyl monomer (a) contained in the hydrophilic segment (B) is 100:0 to 60:40.

Each of the vinyl monomers (a) and (b) may be composed of one kind or two or more kinds of monomers. The vinyl monomers (a) and (b) are selected in accordance with the purpose (for example, to adjust acid content, to adjust glass transition temperature (Tg), to adjust solubility in organic solvent or water, or to adjust dispersion stability).

A content of the functional group relative to the total amount of the block copolymer is preferably 0.05 mmol/g to 5.0 mmol/g, and more preferably, 0.1 mmol/g to 4.5 mmol/g, and especially preferably 0.15 mmol/g to 3.5 mmol/g. In a case where the content of the functional group is too low, dispersion suitability may be reduced. In a case where the content of the functional group is too high, water solubility may become too high or the nanocomposite material may be gelated. In the block copolymer, the functional groups may form salts with cations such as alkali metal ions (for example, Na⁺, K⁺, or the like) or ammonium ions.

The number average molecular weight of the block copolymer is preferably 1000 to 100000, more preferably 2000 to 80000, and especially preferably 3000 to 50000. The block copolymer with the number average molecular weight of at least 1000 forms a stable dispersion. The block copolymer with the number average molecular weight of at most 100000 increases organic solvent solubility.

A refractive index of the block copolymer used in the present invention is preferably at least 1.50, more preferably at least 1.55, furthermore preferably at least 1.60, and especially preferably at least 1.65. The refractive index used herein is measured using Abbe's refractometer (a product of Atago, model: DR-M4) with incident light of 589 nm wavelength.

A glass transition temperature of the block copolymer used in the present invention is preferably in a range of 80° C. to 400° C., and more preferably 130° C. to 380° C. The block copolymer with the glass transition temperature of at least 80° C. increases heat resistance. The block copolymer with the glass transition temperature of at most 400° C. improves processability.

It is preferable that the block copolymer used in the present invention has optical transmittance of at least 80% measured at the wavelength of 589 nm with the thickness of 1 mm. It is more preferable that the optical transmittance is at least 85%.

Specific examples of the block copolymers (illustrated compounds of P-1 to P-20) are listed in the following. However, the block copolymers used in the present invention are not limited to the following specific examples.

TABLE 1
A B

| | | mol | | mol | molecular |
|---|---|---|---|---|---|
| No. | —A— | % | —B— | % | weight |
| P-1 | 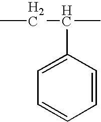 | 90 | 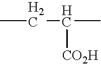 | 10 | 31000 |
| P-2 | 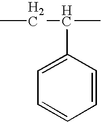 | 95 | 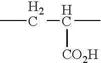 | 5 | 28000 |
| P-3 | 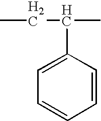 | 80 | 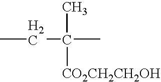 | 20 | 25000 |
| P-4 | 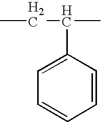 | 90 | 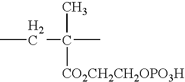 | 10 | 30000 |
| P-5 | 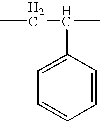 | 85 | 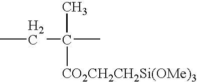 | 15 | 22000 |
| P-6 | 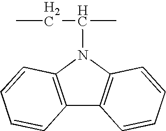 | 88 | 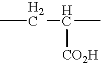 | 12 | 26000 |
| P-7 | 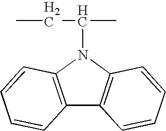 | 92 | 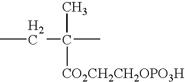 | 8 | 30000 |
| P-8 | 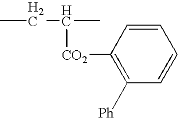 | 90 | 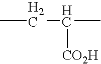 | 10 | 33000 |
| P-9 | 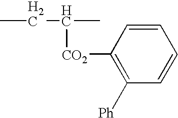 | 93 | 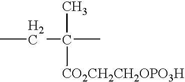 | 7 | 34000 |
| P-10 | 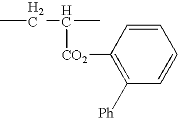 | 80 | 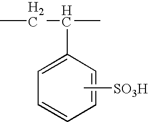 | 20 | 24000 |
| P-11 | 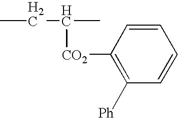 | 90 | 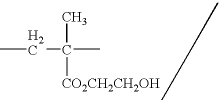 | 10 | 27000 |
| | | | 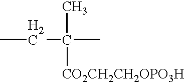 | | |
| P-12 | 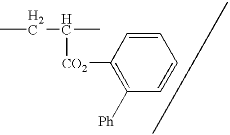 | 95 | 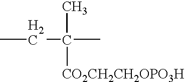 | 5 | 30000 |
| | 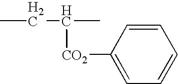 | | | | |

TABLE 2
A B

| | | mol | | mol | molecular |
|---|---|---|---|---|---|
| No. | —A— | % | —B— | % | weight |
| P-13 | 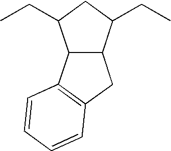 | 90 | 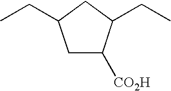 | 10 | 35000 |
| P-14 | 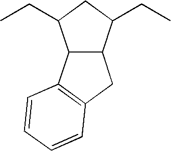 | 95 | 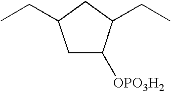 | 5 | 30000 |
| P-15 | 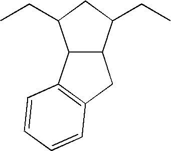 | 80 | 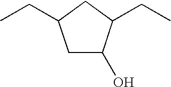 | 20 | 31000 |
| P-16 | 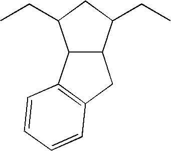 | 95 | 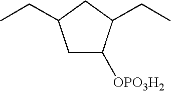 | 5 | 29000 |
| P-17 | 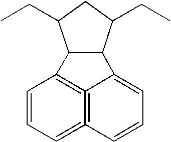 | 88 | 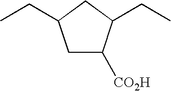 | 12 | 33000 |
| P-18 | 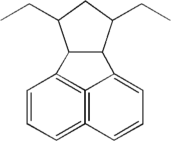 | 90 | 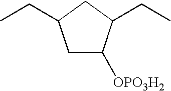 | 10 | 28000 |
| P-19 | 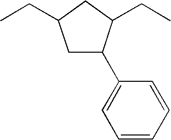 | 85 | 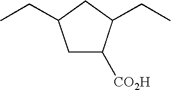 | 15 | 35000 |
| P-20 | 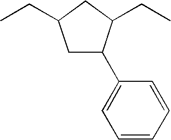 | 93 | 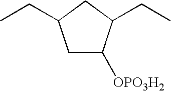 | 7 | 36000 |

The block copolymer is synthesized utilizing living radical polymerization and living ion polymerization, and techniques to protect carboxyl group or introduce a functional group to a polymer as necessary. It is also possible to synthesize the block copolymer by radical polymerization of polymers having terminal functional groups, and formation of bonds between polymers having terminal functional groups. In particular, it is preferable to utilize living radical polymerization and living ion polymerization in view of molecular weight control and yield of block copolymer. Production methods of the block copolymer are described in, for example, “Synthesis and reaction of polymer (1)” edited by The Society of Polymer Science, Japan, and published by Kyoritsu Shuppan, Co., Ltd. (1992), “Precision polymerization” edited by Chemical Society of Japan, and published by Japan Scientific Societies Press (1993), “Synthesis reaction of polymer (1)” edited by The Society of Polymer Science, Japan, and published by Kyoritsu Shuppan Co., Ltd. (1995), ‘Telechelic Polymer: Synthesis, Characterization, and Applications’ by R. Jerome, et al. in pages 837 to 906 of “Progress in Polymer Science”, Vol. 16 (1991), ‘Light-induced synthesis of block and graft copolymers’ by Y. Yagci et al, in pages 551 to 601 of “Progress in Polymer Science”, Vol. 15 (1990), and U.S. Pat. No. 5,085,698.

One kind or a mixture of two or more kinds of the above-described block copolymers may be used.

[Inorganic Fine Particles]

The inorganic fine particles (inorganic nanoparticles) used in the present invention include, for example, oxide fine particles and sulfide fine particles, more specifically, zirconium oxide fine particles, zinc oxide fine particles, titanium oxide fine particles, tin oxide fine particles, and zinc sulfide fine particles. However, the inorganic fine particles are not limited to those. Of those, metal oxide fine particles are especially preferable. In particular, one selected from the group consists of zirconium oxide fine particles, zinc oxide fine particles, tin oxide fine particles and titanium oxide fine particles is preferable, and one selected from the group consists of zirconium oxide fine particles, zinc oxide fine particles, and titanium oxide fine particles is more preferable. Furthermore, it is especially preferable to use zirconium oxide fine particles with low photocatalytic activity and excellent transparency in the visible light region. In the invention, a dispersion of two or more kinds of the above inorganic fine particles may be used in view of refractive index, transparency, and stability. To meet purposes such as reducing photocatalytic activity and a water absorption ratio, the above inorganic fine particles may be doped with different kinds of elements, and surfaces of the inorganic fine particles may be covered with dissimilar metal oxide such as silica and alumina. It is also possible that the inorganic fine particles are surface-modified with silane coupling agent, titanate coupling agent or the like.

Production methods of inorganic fine particles used in the present invention are not particularly limited, and any well-known method can be used. For example, desired fine oxide particles are produced using metal halide or metal alkoxide as a raw material, and hydrolyzing the raw material in a reaction system containing water.

Specifically, following methods to prepare zirconium oxide fine particles and its suspension are known, and any of them may be used: a method to prepare zirconium oxide suspension in which a solution containing zirconium salt is neutralized by an alkali to obtain zirconium hydrate, and the obtained zirconium hydrate is dried and sintered and then dispersed in a solvent; a method to prepare zirconium oxide suspension in which a solution containing zirconium salt is hydrolyzed; a method in which zirconium oxide suspension is prepared by hydrolysis of a solution containing zirconium salt and then the prepared zirconium oxide suspension is ultrafiltered to obtain zirconium oxide; a method to prepare zirconium oxide suspension by hydrolysis of zirconium alkoxide; and a method to prepare zirconium oxide suspension by heating and applying pressure to a solution containing zirconium salt under hydrothermal condition.

Titanyl sulfate is exemplified as a raw material for the synthesis of titanium oxide fine particles. Zinc salts such as zinc acetate and zinc nitrate are exemplified as raw materials for the synthesis of zinc oxide fine particles. Metal alkoxides such as tetraethoxysilane and titanium tetraisopropoxide are also suitable for raw materials of inorganic fine particles. The synthetic methods of such inorganic fine particles include, for example, a method described in pages 4603 to 4608 of Japanese Journal of Applied Physics, vol. 37 (1998), and pages 241 to 246 of Langmuir, vol. 16, issue 1 (2000).

In particular, where oxide fine particles are synthesized by a sol formation method, it is possible to use a procedure of forming a precursor such as a hydroxide, and then dehydrocondensing or peptizing the same with an acid or an alkali, and thereby forming a hydrosol, as in the synthesis of titanium oxide fine particles using titanyl sulfate as a raw material. In such a procedure, it is appropriate that the precursor is isolated and, purified by any known method such as filtration and centrifugal separation in view of purity of a final product. The sol particles in the obtained hydrosol may be insolubilized in water and isolated by adding an appropriate surfactant such as sodium dodecylbenzene sulfonate (abbreviated DBS) or dialkylsulfosuccinate monosodium salt (a product of Sanyo Chemical Industries, Ltd., trade name “ELEMINOL JS-2”) to the hydrosol. For example, the well-known method described in pages 305 to 308 of “Color Material”, vol. 57, 6, (1984) can be used.

In addition to the above-described hydrolysis in water, a method of preparing inorganic fine particles in an organic solvent can be exemplified. In this case, the thermoplastic polymer used in the present invention may be dissolved in the organic solvent.

Examples of the solvent used in the above-mentioned methods include acetone, 2-butanone, dichloromethane, chloroform, toluene, ethyl acetate, cyclohexanone and anisole. One kind or a mixture of two or more kinds of the solvents may be used.

In a case where the number average particle size (diameter) of the inorganic fine particles used in the present invention is too small, intrinsic properties of the inorganic material forming the fine particles may not be exerted, and on the other hand, where it is too large, the impact of Rayleigh scattering becomes significant, reducing transparency of the nanocomposite material drastically. Therefore, the lower limit of the number average particle size of the inorganic fine particles used in the present invention is preferably at least 1 nm, more preferably at least 2 nm, and furthermore preferably at least 3 nm, and the upper limit thereof is preferably at most 15 nm, more preferably at most 10 nm, and furthermore preferably at most 7 nm. Namely, the number average particle size of the inorganic fine particles used in the present invention is preferably from 1 nm to 15 nm, more preferably 2 nm to 10 nm and furthermore preferably from 3 nm to 7 nm. The “number average particle size” used herein is measured using, for example, an X ray diffraction (XRD) device or a transmission electron microscope (TEM).

A refractive index of the inorganic fine particles used in the present invention is preferably in a range of 1.9 to 3.0 at the wavelength of 589 nm at 22° C., and more preferably in a range of 2.0 to 2.7, and especially preferably in a range of 2.1 to 2.5. In a case where the refractive index of the inorganic fine particles is at most 3.0, Rayleigh scattering is suppressed since a difference in refractive indices between the inorganic fine particles and the thermoplastic polymer is not so large. In a case where the refractive index of the inorganic fine particles is at least 1.9, a produced optical lens achieves a high refractive index.

The refractive index of the inorganic fine particles is obtained by, for example, measuring the refractive index of a transparent film made of the nanocomposite material containing the inorganic fine particles and the thermoplastic polymer used in the present invention with Abbe's refractometer (for example, a product of Atago, model: DM-M4), and converting the measured value using a refractive index of the thermoplastic polymer component separately measured. It is also possible to calculate the refractive index of the inorganic fine particles by measuring refractive indices of inorganic fine particle dispersions having different concentrations.

The content of inorganic fine particles in the nanocomposite material of the present invention is preferably 20 mass % to 95 mass %, and more preferably 25 mass % to 70 mass %, and especially preferably 30 mass % to 60 mass % in view of transparency and achieving a high refractive index. In the invention, a mass ratio between the inorganic fine particles and thermoplastic polymer (dispersion polymer) is preferably 1:0.01 to 1:100, and more preferably 1:0.05 to 1:10, and especially preferably 1:0.05 to 1:5 in view of dispersibility.

Although the above described second lens 15 formed from the nanocomposite material containing the thermoplastic polymer and the inorganic fine particles has the higher refractive index than that of the ordinary plastic lens, the second lens 15 is easily damaged by external stress or impact. In particular, the center portion of the concave meniscus type lens body portion 15a is thinner than the peripheral portions thereof and breaks when stress or the like is applied. In this embodiment, the flange 15b of the second lens 15 is made thicker to increase the mechanical strength of the second lens 15.

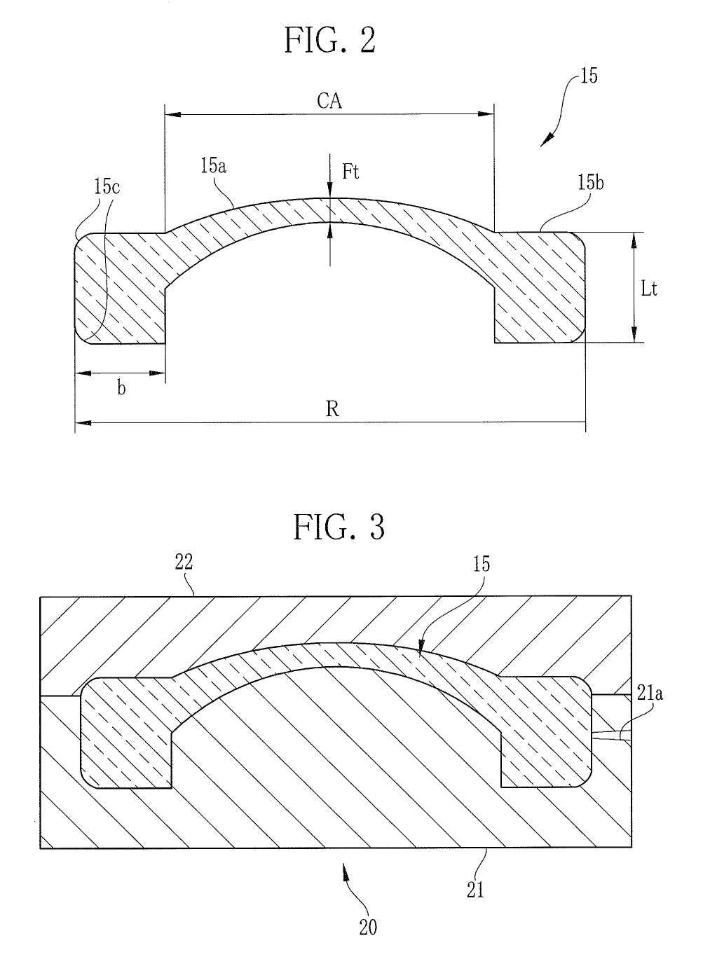

As shown in FIG. 2, “CA” is a diameter (outer diameter) of the lens body portion 15a of the second lens 15. “Ft” is a center thickness of the lens body portion 15a. The center thickness is a thickness of the lens body portion 15a at its center. “Lt” is a thickness (hereinafter referred to as first thickness) of the flange 15b in an optical axis direction O (see FIG. 1). “R” is an outer diameter of the flange 15b. “b” is one-halfa length of a difference between the outer diameter R and the diameter CA. Hereinafter, the length “b” is referred to as second thickness of the flange 15b. The lens body portion 15a and the flange 15b are formed such that the “CA”, the “Ft”, the “Lt” and the “b” satisfy the following mathematical expressions (1) and (2).

1<(Lt/Ft)<5 (1)

(CA/4)≦b (2)

Based on the above mathematical expression (1), the first thickness Lt of the flange 15b is formed to be larger than the center thickness Ft of the lens body portion 15a. A purpose for making the first thickness Lt of the flange 15b less than 5 times as large as the center thickness Ft is to prevent the size (thickness) of the second lens 15 (including the flange 15b) from becoming too large. In addition, a degree of contribution of the flange to the increase in mechanical strength of the lens and protection of the lens reduces in a part of the flange away from the lens body (for example, a lower end of the flange 15b in FIG. 2) as a distance between such part and the lens body portion increases. Based on the above mathematical expression (2), the second thickness b of the flange 15b is formed to be at least ¼ of the diameter CA of the lens body portion 15a.

In the present invention, as described above, external stress or impact is absorbed by the flange 15b and is not transmitted to the lens body portion 15a by increasing the first and second thicknesses Lt and b of the flange 15b of the second lens 15.

In this embodiment, R-chamfering as one type of chamfering processing is performed to a corner portion 15c between a rim surface and a front surface of the flange 15b, and a corner portion 15c between the rim surface and the back surface of the flange 15b. The corner portions 15c are easily chipped on contact with the inner wall of the lens barrel 12 upon external stress or impact. However, such chipping is prevented by performing the R-chamfering to the corner portions 15c in advance as described in this embodiment. Instead of the R-chamfering, other type of chamfering processing such as C-chamfering may be performed to the corner portions 15c. Various chamfering processing such as the R-chamfering may be applied to corner portions other than the above-described corner portions 15c of the flange 15b.

Next, an example of a method for producing the above described second lens 15 is described. As shown in FIG. 3, the second lens 15 is formed using a mold 20. The mold 20 is constituted of a fixed mold 21 and a movable mold 22. To open or close the mold 20, the movable mold 22 is attached to or removed from the fixed mold 21. A cavity is formed on each of opposing surfaces of the fixed mold 21 and the movable mold 22. When the mold 20 is closed, cavities of the fixed mold 21 and the movable mold 22 are joined together as one cavity in the shape of the second lens 15.

After the mold 20 is closed, a heated and melted nanocomposite material is put into an opening 21a formed through the fixed mold 21, and then cooled. Thus, the second lens 15 is formed in the cavity of the mold 20. Then, the movable mold 22 is removed from the fixed mold 21, and the formed second lens 15 is taken out. The first and the third lenses 14 and 16 are formed in the same manner as the second lens 15. The first to the third lenses 14 to 16 are fixed inside the lens barrel 12 formed with another mold or the like.

As described above, in the present invention, the mechanical strength of the second lens 15 is increased by making the first and the second thicknesses Lt and b of the flange 15b of the second lens 15 large. Thereby, external stress or impact to the lens barrel 12 is absorbed by the flange 15b. As a result, the external stress or impact is prevented from being transmitted to the center portion of the lens body portion 15a. The center portion is thinner than the peripheral portions of the lend body portion 15a. Thus, the second lens 15 of the concave meniscus type formed from the nanocomposite material is prevented from breaking easily.

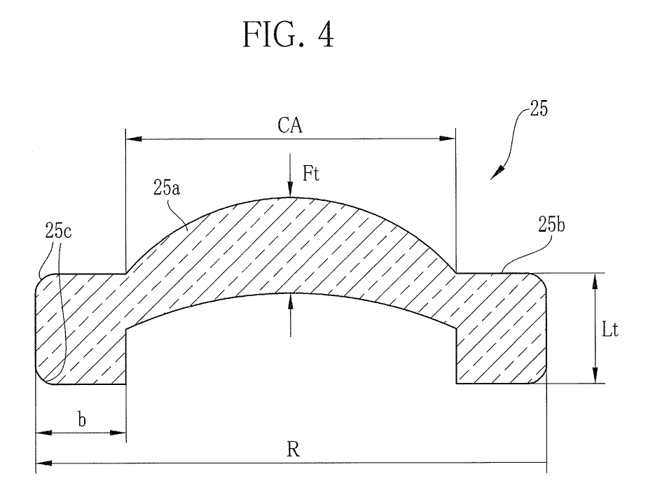

In the above embodiment, the second lens 15 of the concave meniscus type is described as an example. However, the present invention is not limited to the above. For example, as shown in FIG. 4, the present invention is applicable to a lens 25 of a convex meniscus type formed from a nanocomposite material. The lens 25 is constituted of a lens body portion 25a and a flange 25b. Peripheral portions of the lens body portion 25a are made thinner than the center portions thereof. The approximately annular flange 25b is provided along the outer periphery (rim) of the lens body portion 25a.

The lens body portion 25a and the flange 25b are formed such that a diameter CA of the lens body portion 25a, a center thickness Ft of the lens body portion 25a, a first thickness Lt of the flange 25b in the optical axis direction, an outer diameter R of the flange 25b, and a second thickness b that is one-half a length of a difference between the outer diameter R and the diameter CA satisfy the above mathematical expressions (1) and (2) in the same manner as the second lens 15 of the above described embodiment. Therefore, the flange 25b prevents transmission of the external stress or impact to the peripheral portions of the lens body portion 25a. As a result, the mechanical strength of the lens 25 is increased. In addition, the R-Chamfering to corner portions 25c of the flange 25b prevents the chipping of the corner portions 25c as in the case of the second lens 15.

The present invention is not limited to the meniscus type plastic lens. The present invention is also applicable to any plastic lens formed from the nanocomposite material.

In the above embodiments, the lens body portion 15a is formed along the forward edge of the inner circumferential surface of the flange 15b, and the lens body portion 25a is formed along the forward edge of the inner circumferential surface of the flange 25b. However, the positions of the lens bodies are not limited to the above. For example, the lens body portion may be formed along the rear side of the inner circumferential surface of the flange. In addition, the thicknesses of the lens body portion 15a (with the diameter of CA) and the flange 15b may be gradually increased from the center of the lens body portion 15a toward the flange 15b. It is preferred that the first thickness Lt of the flange 15b or 25b may be larger than a thickness of the lens body portion 15a or 25a at an outermost periphery of the diameter CA, respectively.

In the above embodiments, the diameter CA of the lens body portion 15 is the outer diameter of the lens body portion 15a, and the diameter CA of the lens body portion 25a is the outer diameter of the lens body portion 25a. However, the present invention is not limited to them. The diameter CA may be an effective aperture of the lens body portion. Here, the effective aperture of the lens body portion is a maximum diameter of an area of the lens body portion through which light passes, namely, an area of the lens body portion that optically acts as a lens.

In the above embodiments, the plastic lens formed from the nanocomposite material for use in the mobile phone with the camera is described as an example. However, the present invention is not limited to the above. The present invention is applicable to a plastic lens formed from the nanocomposite material for use in an image taking device other than the mobile phone with the camera such as a digital camera and a photographic camera, an image projecting device such as a projector, and the like.

Various changes and modifications are possible in the present invention and may be understood to be within the present invention.

### INDUSTRIAL APPLICABILITY

The present invention is preferably applied to plastic lenses, formed from plastic nanocomposite materials, for use in various image taking devices, image projecting devices, and the like.

1. A plastic lens formed from a plastic nanocomposite material, said plastic nanocomposite material containing inorganic fine particles and thermoplastic polymer, said thermoplastic polymer having a functional group in at least one of a main chain end and a side chain, said functional group being chemically bonded with at least one of said inorganic fine particles, said plastic lens comprising:
a lens body portion; and
a flange formed along an outer periphery of said lens body portion, wherein a diameter CA of said lens body portion, a center thickness Ft of said lens body portion, a thickness Lt of said flange in an optical axis direction, and a length b that is one-half of a difference between an outer diameter of said flange and said diameter CA satisfying 1<(Lt/Ft)<5 and (CA/4)≦b.

2. The plastic lens of claim 1, wherein chamfering is performed to a corner portion of said flange.

3. The plastic lens of claim 1, wherein said thickness Lt is larger than a thickness of said lens body portion at an outermost periphery of said diameter CA.
